(19) United States
(12) Patent Application Publication
(10) Pub. No.: US 2008/0064487 A1
(43) Pub. Date: Mar. 13, 2008

(54) GAMING APPARATUS AND METHOD WITH A DEPENDENT GAME FEATURE

(76) Inventors: Christopher Michael Stevens, Lane Cove (AU); Jennifer Lorna Moroney, Lane Cove (AU)

Correspondence Address: MCANDREWS HELD & MALLOY, LTD, 500 WEST MADISON STREET, SUITE 3400, CHICAGO, IL, 60661, US

(21) Appl. No.: 11/749,018

(22) Filed: May 15, 2007

(30) Foreign Application Priority Data
May 16, 2006 (AU) 2006902598

(51) Int. Cl. A63F 13/00

(52) U.S. Cl. 463/25; 463/31

(57) ABSTRACT

Disclosed is a gaming machine and associated method in which a first and a second game event are provided. At least one characteristic of one or more symbols used in the second game event is variable dependent on the occurrence of one or more special symbols used in the first game event.

### RELATED APPLICATIONS

This application claims priority to an Australian patent application filed on May 16, 2006, as serial number AU2006902598, entitled “Gaming Apparatus and Method with a Dependent Game Feature,” which is herein incorporated by reference in its entirety.

### TECHNICAL FIELD

The present invention relates to gaming machines and apparatus and methods of gaming. In particular, the present invention relates to a gaming machine, and a method of gaming using a gaming machine, that implements a game having a feature game.

### BACKGROUND OF THE INVENTION

With the increase of gambling at gaming venues has come increased competition between gaming venues to obtain a larger share of the total gambling spend. Gaming venue operators have therefore continuously looked for new variations and types of games in order to attract both new and return customers to their venues.

In response to this need, suppliers of gaming devices and systems have attempted to provide the sought after variety, while still developing games that comply with the relevant regulations in the jurisdiction of the gaming venue operator. Suppliers of gaming devices therefore are faced with restrictions on the types of games and gaming apparatus that are allowable, both in terms of the prevailing regulations and in terms of providing a return on investment to the gaming venue operators.

It is common in gaming machines to offer the player feature games. Feature games normally offer an increased return to player and the gaming apparatus must therefore provide enhanced play characteristics in the feature game to provide the required increased return to player. For example, a game may have a return to player of approximately 70% with a hit rate (i.e. the frequency of getting a prize) of about 1 in every 6 games. A feature game of the game may require a return to player of approximately 200% and a hit rate of 1 in 2.

There are many solutions to this problem known to those experienced in game design but there exists a need for alternative solutions. One known solution is to provide a feature game with an increased number of “WILD” symbols, which are symbols that can substitute for any other symbol to form a winning combination.

There are also many methods currently in use to trigger feature games, including the occurrence of scattered symbols in the window, the occurrence of wild symbols in the window, or the occurrence of other special symbols in the window and using background symbols to trigger the feature. Other triggers operate independently of the symbols in the window. However, there still exists a need for alternative methods of triggering a feature game.

The current trend in slot machine games has been to include feature games that rely on video animations or complex mechanical additions to the machine. It is desirable to find games which offer players rewarding features, that can still be offered on physical spinning reel machines where the printed reel strips cannot be altered during play.

Any reference in this specification to the prior art does not constitute an admission that such prior art was well known or forms part of the common general knowledge in any jurisdiction.

### SUMMARY OF THE INVENTION

According to a first aspect of the present invention, there is provided a method of determining an outcome of a game played on a computational gaming apparatus, the method comprising:

providing a first game event in which a first plurality of symbols are selected from a collection of symbols including one or more special symbols, to form one or more first outcomes;

providing a second game event in which a second plurality of symbols are selected from a second collection of symbols to form one or more second outcomes; and

displaying on a display, or causing a display to display, representations of the first game event and the second game event;

wherein at least one characteristic of one or more symbols in the second collection of symbols is variable dependent on the occurrence of one or more said special symbols in the first game event.

Preferably, the method further comprises evaluating at least one of the first and second outcomes for the occurrence of one or more winning outcomes and, dependent on the evaluation, awarding an award.

Preferably, the method comprises evaluating both the first and second outcomes for the occurrence of one or more winning outcomes and, dependent on the evaluation, awarding an award.

According to a second aspect, the invention broadly resides in a gaming apparatus comprising a display and a user interface in communication with a game controller for providing a game in which a plurality of symbols are selected to form one or more outcomes and if a particular outcome results the gaming apparatus awards an award, the gaming apparatus operable to:

provide a first game event in which a first plurality of symbols are selected from a collection of symbols including one or more special symbols, to form one or more outcomes,

provide a second game event in which a second plurality of symbols are selected from a second collection of symbols to form one or more second outcomes, the second game event having at least one symbol with at least one variable characteristic that depends at least in part on the occurrence of the special symbols in the first game event; and

display on a display, or cause a display to display, representations of the first game event and the second game event.

Preferably, there are at least two different types of said special symbols, wherein the occurrence of a first type of special symbol results in variation of one or more characteristics of a first symbol in the second collection of symbols and the occurrence of a second type of special symbol results in variation of one or more characteristics of a second symbol in the second collection of symbols.

Preferably, the second collection of symbols comprises at least some of the same symbols from the first collection of symbols. More preferably, the second collection of symbols comprises all or all but the special symbols from the first collection of symbols. In the most preferred embodiment as presently contemplated, the special symbols do not form part of the second collection of symbols.

Preferably, the second game event has enhanced play characteristics in comparison to the first game event, the enhanced play characteristics dependent at least in part on the occurrence of the special symbols in the first game event.

Preferably, the characteristic or characteristics that depend at least in part on the occurrence of the special symbols in the first game event are characteristics that result in the second game event having a higher return to player than the first game event.

Preferably, the second game event is a feature game that is provided on the occurrence of one or both of a particular said special symbol and a particular combination of said special symbols in the first game event.

Preferably, the first game event and second game event are defined by the spinning up of said symbols on a plurality of spinning reels. Each spinning reel may be a physical reel.

Preferably, the special symbols each indicate to a player which symbol or symbols in the second collection of symbols are to have varied characteristics due to the occurrence of that special symbol.

Preferably, one part of each said special symbol indicates to a player that it is a special symbol and another part indicates to the player the symbols in the second collection of symbols are to have varied characteristics due to the occurrence of that special symbol.

Preferably, the variable characteristics of a symbol comprise at least one of:

a) the frequency of occurrence of the symbol;

b) whether the symbol substitutes for one or more other symbols to define a winning combination;

c) whether the symbol needs to be displayed in a particular symbol position to form part of a winning combination; and

d) whether the symbol has a multiplier associated with it that multiplies the award payable on the occurrence of a winning combination.

In one embodiment, the first game event comprises two stages, one stage comprising selecting what special symbols, if any, are selected and another stage selecting what other symbols in the collection of symbols are selected. Preferably, the special symbols are associated with at least one of said other symbols, and said other symbols are present in the second game event and have at least one characteristic varied because of the association. Preferably, the association is visually communicated to a player by locating the special symbol at the same symbol position as the symbol or symbols with which it is associated.

According to a third aspect of the present invention, there is provided a method of providing a game, the method comprising in a computational gaming apparatus defining a collection of symbols and using the collection of symbols to form one or more outcomes, evaluating the outcomes for the occurrence of one or more winning outcomes and dependent on the evaluation award an award, the step of forming one or more outcomes comprising:

a) randomly selecting a plurality of symbols from the collection of symbols, the selected symbols defining a first set of symbols; and

b) randomly selecting a second set of symbols from the collection of symbols and associating each said further symbol with one or more of the first set of symbols, thereby defining one or more associated symbols in the first set of symbols;

the method further comprising:

c) providing a feature game having enhanced play relative to said game and that uses at least part of the collection of symbols, wherein the enhanced play results from modification of at least one characteristic of at least one of the associated symbols; and

d) displaying on a display, or causing a display to display, representations of play of the game and the feature game.

According to a fourth aspect, the invention broadly resides in a gaming apparatus comprising a display and a user interface in communication with a game controller for providing a game in which a plurality of symbols are selected from a collection of symbols to form one or more outcomes and if a particular outcome results the gaming apparatus awards an award, the gaming apparatus operable to:

a) randomly select a plurality of symbols from the collection of symbols, the selected symbols defining a first set of symbols;

b) randomly select a second set of symbols from the collection of symbols and associating each said further symbol with one or more of the symbols from the first set of symbols, thereby defining one or more associated symbols in the first set of symbols;

c) provide a feature game having enhanced play relative to said game and that uses at least part of the collection of symbols, wherein the enhanced play results from modification of at least one characteristic of at least one of the associated symbols; and

d) display on the display representations of play of the game and the feature game.

Preferably, the gaming apparatus is further operable to use the first set of symbols and the second set of symbols to define the one or more outcomes.

Preferably, the feature game is provided on the occurrence of one or both of a particular symbol in the second set of symbols or a particular combination of symbols in the second set of symbols.

Preferably, the collection of symbols comprises a first collection and a second collection of symbols, wherein the first set of symbols are formed by selecting from the first collection and the second set of symbols are formed by selecting from the second collection. The symbols in the first collection and the second collection may be mutually exclusive. The symbols from the second collection may not be used in the feature game. Preferably, the game and the feature game are both spinning reel games that use the first collection of symbols on the spinning reels.

Preferably, the collection of symbols is defined by symbols on a plurality of reel strips each forming part of a spinning reel, and the step of forming one or more outcomes comprising spinning up the first set of symbols and the second set of symbols on the spinning reels. Each spinning reel may be a physical reel. The one or more winning outcomes may include the spinning up of a predetermined combination of symbols on the spinning reels.

Preferably, the representations of play of the game comprise a representation of each symbol in the first set of symbols in a symbol position and a representation of the associated symbols in the same symbol position as the symbol in the first set of symbols with which they are associated. The size of the symbols in the first set of symbols may be reduced so that both the symbol from the first set of symbols and its associated symbol may be displayed in the same symbol position.

Preferably, the second set of symbols includes a plurality of types of symbols, each type having multiple occurrences and enhanced play results from modification of at least one characteristic of every one of the multiple occurrences of a type of symbol.

Preferably, the at least one characteristic comprises at least one of:

a) the frequency of occurrence of the symbol;

b) whether the symbol substitutes for one or more other symbols to define a winning combination;

c) whether the symbol needs to be displayed in a particular symbol position to form part of a winning combination; and

d) whether the symbol has a multiplier associated with it that multiplies the award payable on the occurrence of a winning combination.

According to a fifth aspect of the invention, there is provided a method of determining an outcome of a game played on a computational gaming apparatus, the method comprising:

providing a first game event in which one or more first outcomes are formed by selecting a first plurality of symbols from a collection of symbols that includes a plurality of groups of related symbols, wherein for at least one of the groups of like symbols at least one, but less than all of the symbols in the group is designated a special symbol;

determining whether a trigger event has occurred during play of the first game event;

if the trigger event occurred during play of the first game event, determining whether a said special symbol has occurred in the first game event and if so, modifying the collection of symbols by changing at least one characteristic of all symbols in the same group as the special symbol and then providing a second game event in which one or more second outcomes are formed by selecting a second plurality of symbols from the modified collection of symbols;

evaluating whether a winning combination has occurred as a result of the first game event or the second game event and awarding an award if it is determined that a winning combination has occurred, wherein the modification to the collection of symbols results in at least one of an increased probability that a winning combination will occur in the second game event and the award of a larger award if a winning combination does occur in the second game event; and

displaying on a display, or causing a display to display representations of the first game event and the second game event.

In one embodiment, a symbol is designated as a said special symbol by having a background symbol associated with it, wherein the process of displaying or causing a display to display representations of the first game event include displaying in a same symbol display position any occurring special symbol and its associated background symbol.

In one embodiment, the relation between symbols in a group is identity.

According to a sixth aspect of the invention, there is provided a gaming apparatus comprising a display and a user interface in communication with a game controller for providing a game in which a plurality of symbols are selected from a collection of symbols to form one or more outcomes and if a particular outcome results the gaming apparatus awards an award, wherein the gaming apparatus operates to:

provide a first game event in which one or more first outcomes are formed by selecting a first plurality of symbols from a collection of symbols that includes a plurality of groups of related symbols, wherein for at least one of the groups of like symbols at least one, but less than all of the symbols in the group is designated a special symbol;

determine whether a trigger event has occurred during play of the first game event;

if the trigger event occurred during play of the first game event, determining whether a said special symbol has occurred in the first game event and if so, modifying the collection of symbols by changing at least one characteristic of all symbols in the same group as the special symbol and then providing a second game event in which one or more second outcomes are formed by selecting a second plurality of symbols from the modified collection of symbols;

evaluate whether a winning combination has occurred as a result of the first game event or the second game event and awarding an award if it is determined that a winning combination has occurred, wherein the modification to the collection of symbols results in at least one of an increased probability that a winning combination will occur in the second game event and the award of a larger award if a winning combination does occur in the second game event; and

display on a display, or causing a display to display representations of the first game event and the second game event.

Further aspects of the present invention and further embodiments of the aspects described in the preceding paragraphs, will become apparent from the following description, given by way of example and with reference to the accompanying drawings.

### BRIEF DESCRIPTION OF THE DRAWINGS

Notwithstanding any other embodiments that may fall within the scope of the present invention, certain embodiments of the present invention will now be described, by way of example only, with reference to the accompanying figures, in which:

FIG. 1 shows diagrammatically, a view of a gaming machine suitable for implementing an embodiment of the present invention.

FIG. 2 shows a block diagram of gaming apparatus suitable for implementing an embodiment of the present invention.

FIG. 3 shows a block diagram of components of the memory of the gaming apparatus represented in FIG. 2.

FIG. 4 shows diagrammatically, a network gaming system suitable for implementing an embodiment of the present invention.

FIGS. 5 to 7 show exemplary screen shots from a display presenting a game in accordance with an embodiment of the present invention.

FIG. 8 shows a flow diagram of a game process to be implemented by a gaming apparatus or gaming system of certain embodiments of the present invention.

FIG. 9 shows part of a display of a gaming apparatus according to another embodiment of the present invention.

### DESCRIPTION OF THE INVENTION

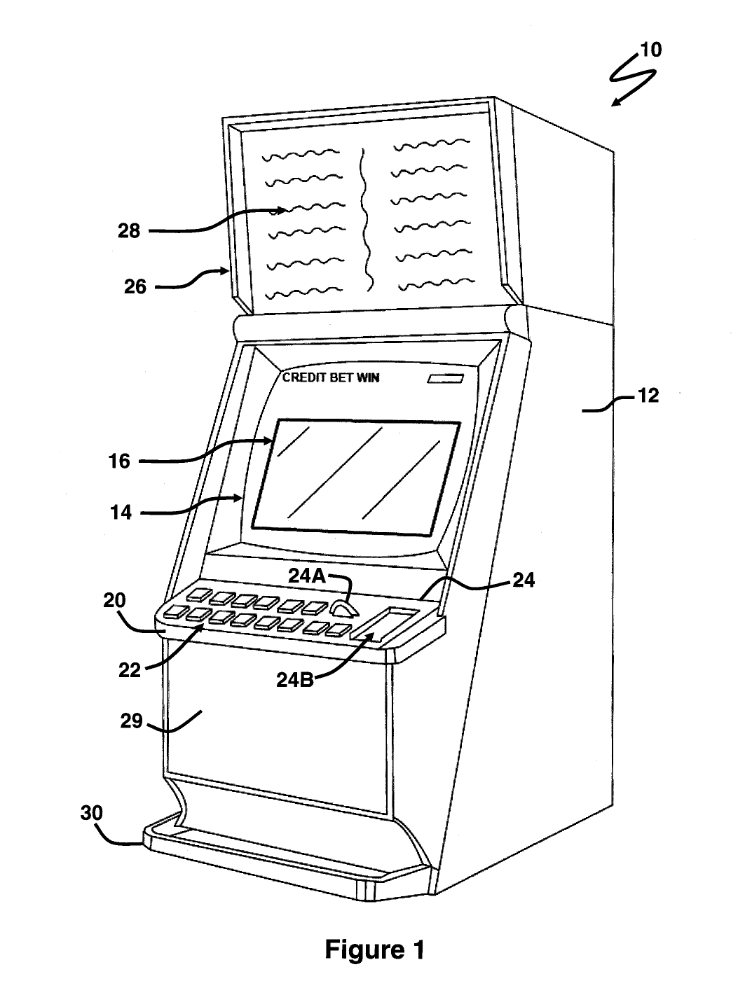

In FIG. 1 of the accompanying drawings, a gaming machine suitable for implementing an embodiment of the present invention is generally referenced by arrow 10. The gaming machine 10 is one example of a gaming apparatus that is suitable to implement an embodiment of the present invention.

The gaming machine 10 includes a console 12 having a display 14 on which is displayed representations of a game 16, that can be played by a player. A mid-trim 20 of the gaming machine 10 houses a bank of buttons 22 for enabling a player to play the game 16. The mid-trim 20 also houses a credit input mechanism 24 including a coin input chute 24A and a bill collector 24B. A top box 26 may carry artwork 28, including for example, pay tables and details of bonus awards and other information or images relating to the game. Further artwork and/or information may be provided on the front panel 29 of the console 12. A coin tray 30 is mounted beneath the console 12 for cash payouts from the gaming machine 10.

The display 14 shown in FIG. 1 is in the form of a video display unit, particularly a cathode ray tube screen device. Alternatively, the display 14 may be a liquid crystal display, plasma screen, any other suitable video display unit, or the visible portion of an electromechanical device. In this latter respect, if the game 16 is a spinning reel game, the display 14 may use a stepper motor to control the position of physical reels. The top box 26 may also be a display, for example a video display unit, which may be the same type as the display 14, or a different type of display.

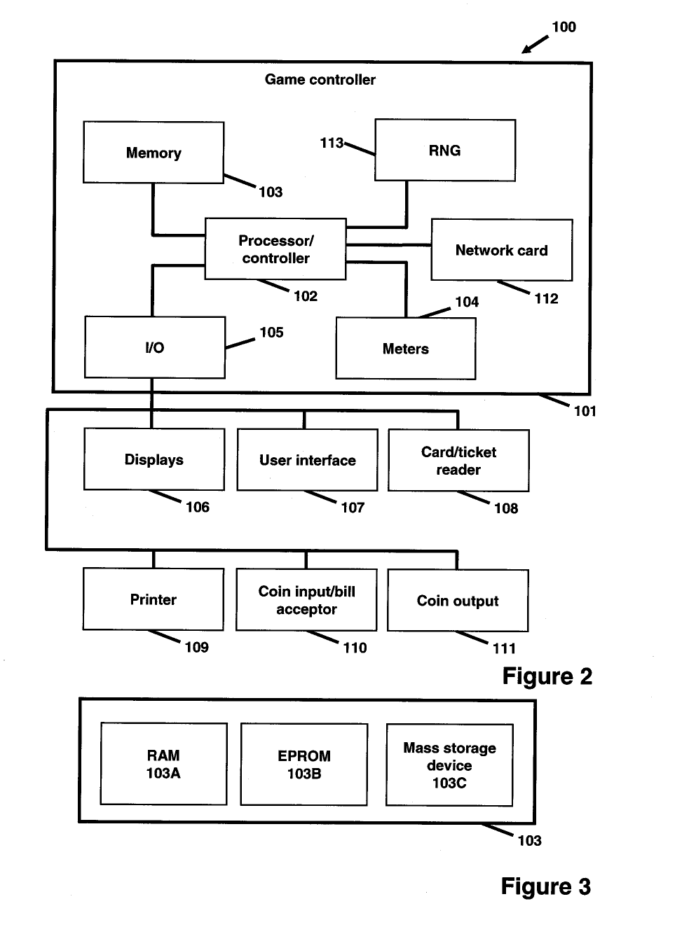

FIG. 2 shows a block diagram of a gaming apparatus, generally referenced by arrow 100, suitable for implementing an embodiment of the present invention. The gaming apparatus 100 may, for example, operate as a standalone gaming machine of the type shown in FIG. 1. However, the gaming apparatus 100 may alternatively operate as a networked gaming machine, communicating with other network devices, such as one or more servers or other gaming machines. The gaming apparatus 100 may have distributed hardware and software components that communicate with each other directly or through a network. Accordingly, different reference numerals have been used in FIG. 2 from FIG. 1 for components that may be equivalent.

The gaming apparatus 100 includes a game controller 101, which in the illustrated example includes a microprocessor, microcontroller, programmable logic device or other computational device 102. Instructions and data to control operation of the computational device 102 are stored in a memory 103, which is in data communication with the computational device 102. Typically, the gaming apparatus 100 will include both volatile and non-volatile memory and more than one of each type of memory, with such memories being collectively represented by the memory 103. In addition, the computational device 102 may include two or more computational devices that each perform computational functions and which may be located locally or remotely from each other. The instructions to cause the game controller 101 to implement an embodiment of the present invention will be stored in the memory 103.

The gaming apparatus may include meters 104 for the purposes of regulatory compliance and also include an input/output (I/O) interface 105 for communicating with the peripheral devices of the gaming apparatus 100. The input/output interface 105 and/or the peripheral devices may be intelligent devices with their own memory for instructions and data.

In the example shown in FIG. 2, the peripheral devices that communicate with the controller are one or more displays 106, user interfaces 107, a card and/or ticket reader 108, a printer 109, a bill acceptor and/or coin input mechanism 110 and a coin output mechanism 111. Additional devices may be included in the gaming apparatus 100 or devices omitted as required. One or more of the peripheral devices may be an intelligent peripheral device, having its own memory containing instructions and data.

In addition, the gaming apparatus 100 may include a communications interface, for example a network card 112 to communicate with a network for such purposes as sending status information, accounting information and the like to a central controller, allowing communication from the central controller to the gaming apparatus 100 or for other purposes. In one embodiment, the functions of the computational device 102 may be split between a remote device and a local device, for example with game outcomes generated remotely and game graphics for the display 106 generated locally. In another embodiment, the peripheral devices only may be provided locally together with a network interface, in which case all, or nearly all intelligent devices may be located remotely of the display 106.

FIG. 3 shows an exemplary block diagram of the main components of the memory 103. The RAM 103A typically temporarily holds instructions and data related to the execution of game programs and communication functions performed by the computational controller 102. The EPROM 103B may be a boot ROM device and/or may contain system and game related code. The mass storage device 103C may be used to store game programs, the integrity of which may be verified and/or authenticated by the computational controller 102 using protected code from the EPROM 103B or elsewhere.

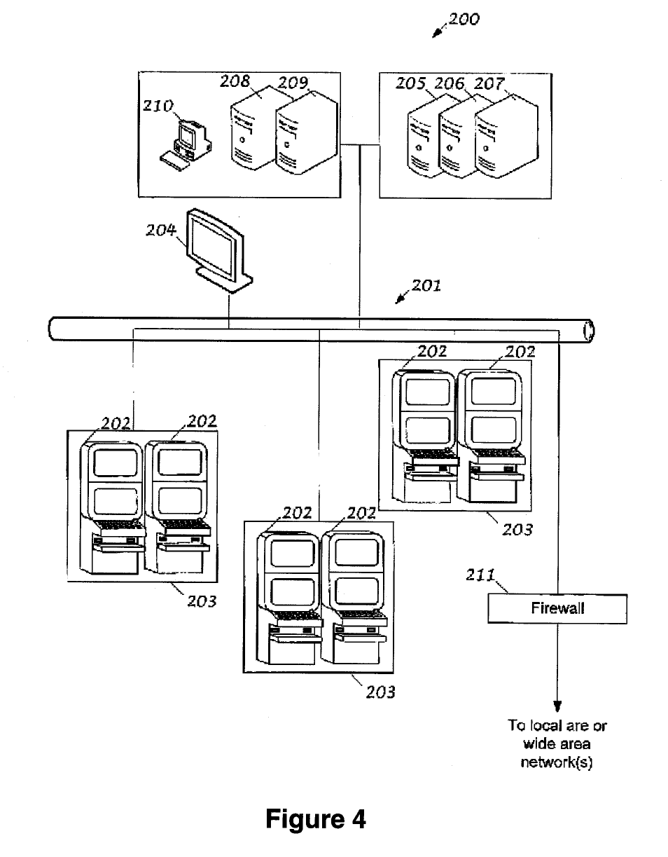

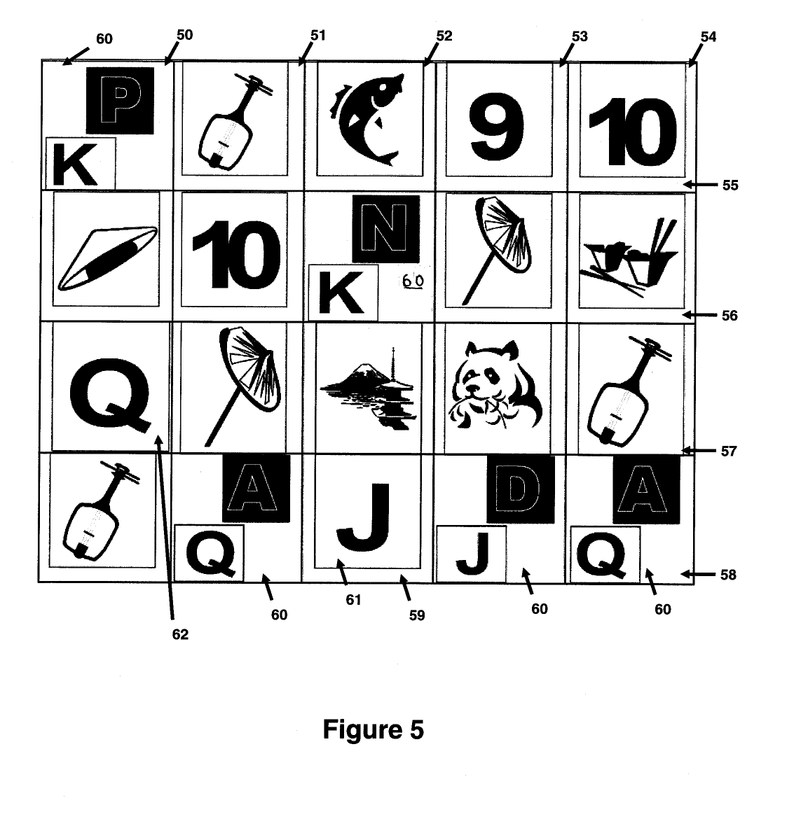

FIG. 4 shows a gaming system 200. The gaming system 200 includes a network 201, which for example may be an Ethernet network. Gaming devices 202, shown arranged in three banks 203 of two gaming devices 202 in FIG. 4, are connected to the network 201. The gaming devices 202 may be gaming machines 10, as shown in FIG. 1 or form part or all of another gaming apparatus 100. Single gaming devices 202 and banks 203 containing three or more gaming devices 202 may also be connected to the network 201.

One or more displays 204 may also be connected to the network 201. The displays 204 may, for example, be associated with a bank 203 of gaming devices. The displays 204 may be used to display representations associated with game play on the gaming devices 202, and/or used to display other representations, for example promotional or informational material.

Servers may also be connected to the network 201. For example, a game server 205 may generate game outcomes for games played on the gaming devices 202, a database management server 206 may store game programs and associated data for downloading or access by the gaming devices 202 and a jackpot server 207 may control one or more jackpots associated with the gaming devices 202.

Further servers may be provided to assist in the administration of the gaming system 200, including for example a gaming floor management server 208, and a licensing server 209 to monitor the use of licenses to particular games. An administrator terminal 210 is provided to allow an administrator to run the network 201 and the devices connected to the network.

The gaming system 200 may communicate with other gaming systems, other local networks, for example a corporate network and/or a wide area network such as the Internet through a firewall 211.

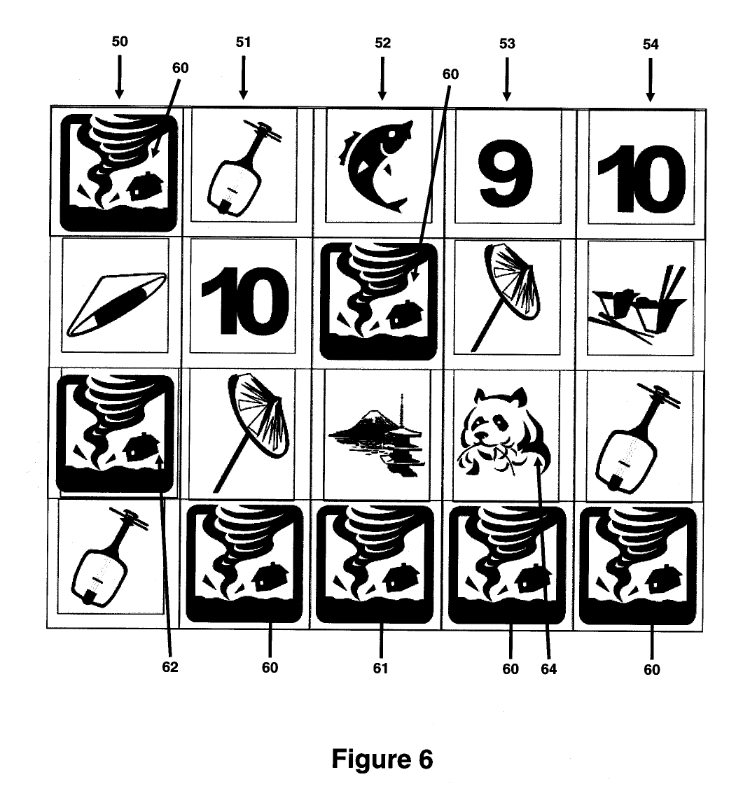

FIGS. 5 to 7 show a series of three screen shots that may be displayed on a display of a gaming apparatus 100 or gaming system 200, according to an embodiment of the present invention. Those skilled in the relevant arts will appreciate that the foregoing description of a gaming machine 10, gaming apparatus 100 and gaming system 200 represent possible environments in which certain embodiments of the present invention may be implemented and that other gaming environments will also be suitable to implement certain embodiments of the invention or may be readily adapted to implement certain embodiments of the invention.

The screen shots show a game with a theme centred on the panda. The game shown in FIGS. 5 to 7 is a spinning reel game with five reels 50-54, each displaying on the display four symbol positions 55-58. In the embodiment shown the five reels define five columns and the four symbol positions 55-58 define four rows that span the reels. Accordingly a total of 20 symbol positions 59 (one only indicated by a reference numeral in FIG. 5) are defined in an array that in this embodiment is a four by five matrix.

Those skilled in the relevant arts will appreciate that certain embodiments of the present invention may also have application to game types other than spinning reel games. For example and without limitation, certain embodiments of the present invention may have application to card or dice games.

FIG. 5 shows a screen shot of play of a game according to certain embodiments of the present invention on the occurrence of a feature trigger event. A selection of a set of 20 symbols is made from a collection of previously defined symbols, with each symbol being displayed in one of the symbol positions 59. Because the game is a spinning reel game, the selection is made by selecting the stopping position of each of the spinning reels 50-54, which may be based on the output from the random number generator 113.

The collection of symbols includes one or more special symbols 60. In FIG. 5 five special symbols 60 have been spun up, one on each of the reels 50-54. Each special symbol 60 contains a representation of one of the letters in the word “PANDA” and a representation of an ordinary symbol. Reel 50 may only contain special symbols that represent a “P”, reel 51 may only contain special symbols that represent an “A” and so on for reels 52 to 54. The feature trigger event in this example is the spinning up of a combination of special symbols so as to spell “PANDA” across the reels.

The triggering of the feature game (or a second game event) is in the preferred embodiment as presently contemplated related to the spinning up of one or more special symbols, more preferably a combination of special symbols. However, in alternative embodiments a single occurrence of a special symbol may be sufficient to trigger the feature game, or another combination of special symbols may be the trigger event, including obtaining multiple special symbols of the same type or a related type.

Alternatively, the trigger event may be unrelated to the spinning up of the special symbols, for example getting scattered symbols in the window, getting wild symbols in the window, getting some other symbol or symbols in the window and using background symbols that do not define special symbols to influence symbols in the feature game. In these alternative embodiments, the occurrence of special symbols together with the trigger event, which may include any of a variety of events or conditions, still determines the extent to which symbols are modified in the feature game (see herein below).

In the example provided, the special symbols are limited to “royal” symbols, the “royal” symbols being those that represent a “J”, “Q” or “K”, corresponding to a “Jack”, “Queen”, or “King” in a standard deck of cards. However, the special symbols need not be limited to the representation of any particular ordinary symbol, or display any ordinary symbol at all, although in the preferred embodiment as presently contemplated the special symbols all display a representation of an ordinary symbol.

A second game event, which may be a feature game, is triggered by the spelling of the word “PANDA” across the screen. The second game event may be, for example, a series of five free games, although it could also be a paid game event. Other types of second game events may be provided. Therefore, after the 20 symbols have been selected and displayed as shown in FIG. 5, a jackpot bell may sound, any wins on screen are paid and the player may be prompted to press a “start feature” button on the bank of buttons 22 to commence play of the feature game.

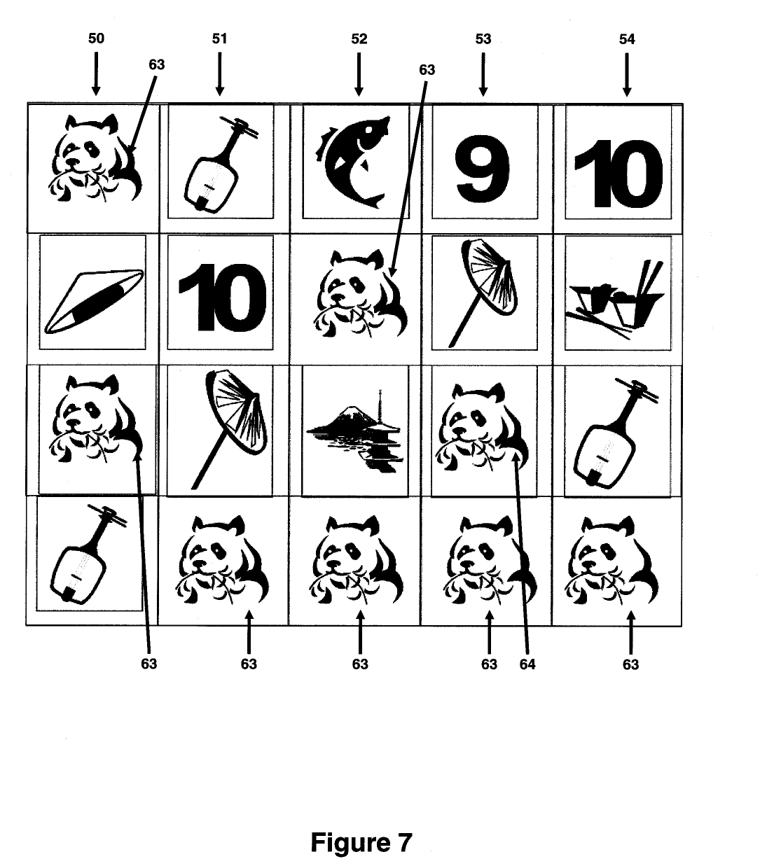

When the player presses the “start feature” button, an animation may occur to represent a transformation of the special symbols and all the ordinary symbols displayed on screen that are represented by the special symbols into WILD symbols. An example of this process is shown in FIG. 6, where the animation is a representation of a tornado and the WILD symbol is a representation of a panda. Because at least one of the special symbols 60 spun up in the game screen shown in FIG. 5 represented a “J”, “Q” and “K”, all of these symbols may be transformed into WILD symbols. In the example shown, the “J” symbol 61 and “Q” symbol 62 are therefore also transformed. Therefore, the second game event is played with a second collection of symbols that include these additional WILD symbols.

An alternative animation sequence may include the letters forming PANDA to move into the middle of the screen and a message to be displayed in the form “All X are now wild symbols” or “All X are now PANDAS” or similar, where ‘X’ indicates the symbols that are modified due to being spun up with the special symbols PANDA. Therefore, following the game shown in FIG. 5, the message may say “All J, Q, K are now PANDAS”. Of course, while in the example shown in FIG. 5 all three ‘royal’ symbols have been spun up with associated special symbols, depending on the reel design, this may not occur every time the special symbols PANDA are spun up.

In alternative embodiments the animation sequence may be omitted, with the game simply switching between the primary or base game and the feature game.

Play of the feature game commences with a re-spin of the reels 50-54, with an exemplary screen shot following the re-spin shown in FIG. 7. Because the “J”, “Q” and “K” have all been replaced by the WILD “PANDA” symbol 63, there is an increased chance of winning a prize in the feature game. Because the special symbols have been transformed into WILD symbols, they do not occur during the feature game. Additional WILD symbols may also occur in the feature game independently of those that have been transformed, for example WILD symbol 64.

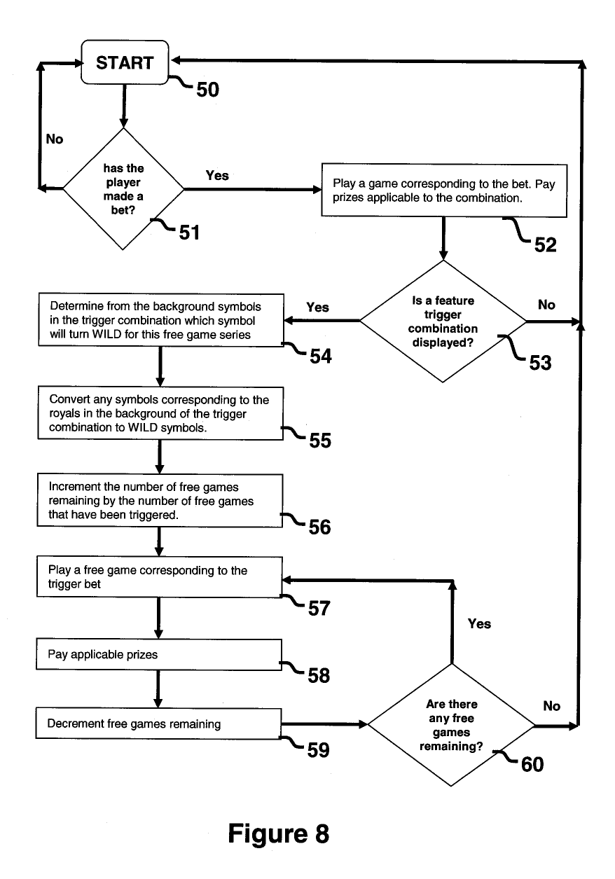

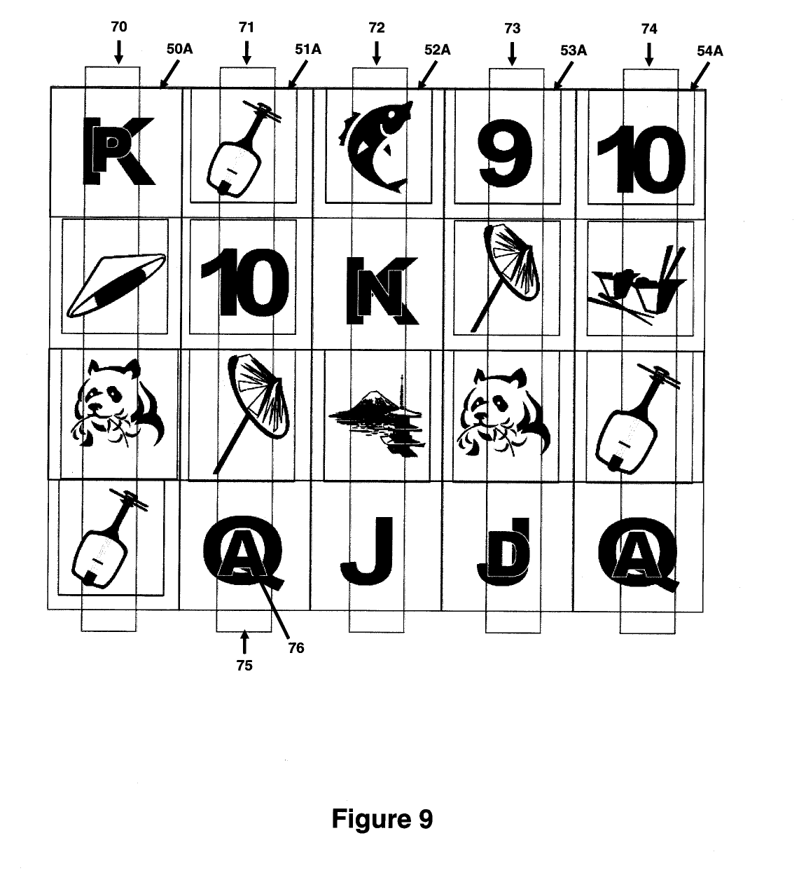

FIG. 8 shows a flow diagram of a process to be implemented by the gaming machine 10, gaming apparatus 100 or gaming system 200 in accordance with an embodiment of the invention. The process may result in the screen shots shown in FIGS. 5 to 7. For clarity, the following description assumes that the process is performed by a gaming system 100 in the form of the gaming machine 10.

The process starts at step 50, with the gaming machine 10 performing any necessary initialisation procedures, for example executing boot code, loading an operating system and commencing execution of a game program stored in memory 103. The game program contains instructions to cause the computational controller 102 to perform the operations in the flow diagram.

The computational controller 102 monitors the bank of buttons 22 or other user interface device for the placement of a bet (step 51). If a bet has been placed, then the gaming machine 10 in step 52 provides a game to the player, evaluates the outcome(s) of the game and awards an award or prize if a winning combination occurs in the outcome(s), according to a pay table, which is also stored in the memory 103. The screen shot in FIG. 5 shows the game at step 52.

Next, the computational controller 102 determines whether a feature has been triggered (step 53). If the feature has not been triggered, the process returns to step 50, optionally via one or more additional steps that may provide a second chance or allow a player to wager any winnings that they may have been determined to be entitled to in step 52. If the feature has been triggered, the process proceeds to step 54.

In step 54 the special symbols that have been spun up to trigger the feature are evaluated and the symbols that need to be transformed into WILD symbols determined. In the example shown in FIG. 5, the special symbols and the “J”, “Q” and “K” symbols all require transformation. Different game outcomes can result in different symbols requiring transformation. For example, if in the screen shot in FIG. 5 all the special symbols displayed a representation of the ordinary “Q” symbol as well as one of the letters from the word “PANDA”, then only the special symbols and the “Q” symbols are determined as requiring transformation into WILD symbols.

In step 55 the symbols requiring transformation as determined in step 54 are transformed into WILD symbols. The screen shot in FIG. 6 shows the game at step 55.

Step 56 involves setting a counter for the feature game, which in this example is a series of free games and step 57 involves playing the first of the free games. The screen shot in FIG. 7 shows the game at step 57. The free games may be played according the size of the bet detected in step 51. For example, if the player placed a wager of one credit on three pay lines, then the feature game may also only pay on three lines. If the player placed a wager of two credits on nine pay lines, then the feature game may play on nine lines and the prizes payable in the feature game may be doubled.

Step 58 involves paying the prizes, if any, applicable to the free game, which typically involves adding the applicable prize to a win meter. Step 59 involves decrementing the count of free games remaining and steps 57 to 59 are repeated until the free games have been exhausted. Once the free games have been exhausted, as determined at step 60, then the value in the win meter may be transferred to the main credit meter or one or more other processes may be performed, for example allowing a player to wager some or all of the value in the win meter for additional or alternative awards.

As described in the foregoing description, the currently contemplated preferred embodiment of the invention involves the use of multiple types of special symbols in the first game event, with different types of special symbol causing the variation of the characteristics of different symbols in the second game event, the variation being the same—all associated symbols transforming into WILD symbols. However, different types of special symbols may in alternative embodiments of the invention cause different variations in their associated symbols in the feature game.

Also, a single special symbol could be provided in the first game event, which modifies the characteristics of one or more predefined symbols in the second collection of symbols. If duplicates of special symbols can occur in the first game event, then the duplicates may have no additional affect on the second game event, may increase the variation of the characteristics of one symbol in the second collection of symbols or may cause a variation in a different symbol in the second collection of symbols.

An example of an increase in the variation of the characteristics of one symbol is that a first special symbol may result in half of the “Q” symbols in the second collection to become “WILD” symbols, the second may result in the other half becoming WILD symbols and the third, may have no affect or another affect on the second game event. Another example is that the first special symbol results in the “Q” symbols in the second collection acting as a multiplier by two, the second special symbol resulting in the “Q” symbols acting as a multiplier by three and so on. A still further example is that the first special symbol results it a symbol becoming WILD and a second special symbol results in that symbol or another symbol becoming a multiplier for the awards won in the second game event.

Alternatively or in addition, duplicates may affect the second game event in another way. For example, each duplicate special symbol may result in five additional free games being awarded.

A single special symbol may cause the variation of two or more characteristics of a symbol or symbol type in the second collection of symbols and/or may cause the variation of characteristics of two or more different symbols or symbol types in the second collection of symbols.

The special symbols need not necessarily be removed from the second collection of symbols. If the special symbols are retained, they may act as ordinary symbols in the second game event, act as a WILD symbol, or act to retrigger the second game event.

In another embodiment of the present invention, the first game event may be a multi-stage process. One stage may comprise the selection of what special symbols, if any, to select and display. Another stage may comprise the selection of what other symbols to select and display. These two stages may be completed simultaneously or consecutively, in either order.

FIG. 9 shows an example of this multi-stage process embodiment of the present invention. Like the game described herein with reference to FIGS. 5 to 7, the game has five spinning reels 50A-54A similar to reels 50-54 in FIG. 5. The reels 50A-54A may be implemented as physical spinning reels controlled by a stepper motor, or as representations on an electronic display. If this embodiment and other embodiments described herein are implemented as physical reels, unless a form of electronic wallpaper or similar technology is used, the modification of symbols for the feature game will occur solely in the background, with no change in the actual symbols on the reels.

In addition, five further reels 70-74 are provided. The reels 70-74 may also be implemented as physical spinning reels or using an electronic display. In the multi-stage process embodiment with physical spinning reels for both the reels 50A-54A and reels 70-74, the reels need to be able to be spun independently of each other. If the process is a single stage process, then the reels 50A-54A and 70-74 may be rotated synchronously, effectively together defining a single spinning reel.

The reels 70-74 may have transparent or translucent carriers 75 and/or translucent symbols 76 to enable the symbols on the reels 50A-54A to be viewed through the reels 70-74. It will be appreciated that many different visual affects could be obtained by combining representations on reels 70-74 with those on reels 50A-54A.

Like the game described with reference to FIGS. 5 to 7, the special symbols are one of the letters of the word “PANDA”, with reel 70 containing the letter “P”, reel 71 containing the letter “A” and so forth. The reels 70-74 may also contain other letters that do not act as special symbols. If the word “PANDA” is spelled across the reels 70-74, then a feature game is commenced with the symbols that are associated with the special symbols having one or more characteristics varied, again in this example the “J”, “Q” and “K” symbols. The reels 70-74 if implemented as physical reels may remain stationary, move to a position with no symbols displayed, or spin in the feature game, depending on the requirements for that particular game.

While the foregoing description has been provided by way of example of the preferred embodiments of the present invention as presently contemplated, which utilise gaming apparatus, those skilled in the relevant arts will appreciate that the present invention also may have application to internet gaming and/or have application to gaming over a telecommunications network, where handsets are used to display game outcomes and receive player inputs.

Where in the foregoing description reference has been made to integers having known equivalents, then those equivalents are hereby incorporated herein as if individually set forth.

Those skilled in the relevant arts will appreciate that modifications and additions to the embodiments of the present invention may be made without departing from the scope of the present invention.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1. A method of determining an outcome of a game played on a computational gaming apparatus, the method comprising:
providing a first game event in which a first plurality of symbols are selected from a collection of symbols that includes one or more special symbols, to form one or more first outcomes;
providing a second game event in which a second plurality of symbols are selected from a second collection of symbols to form one or more second outcomes; and
displaying on a display, or causing a display to display representations of the first game event and the second game event;
wherein at least one characteristic of one or more symbols in the second collection of symbols is variable dependent on the occurrence of one or more of the special symbols in the first game event.

2. The method of claim 1 further comprising evaluating at least one of the first and second outcomes for the occurrence of one or more winning outcomes and dependent on the evaluation, awarding an award.

3. The method of claim 1, further comprising evaluating both the first and second outcomes for the occurrence of one or more winning outcomes and, dependent on the evaluation, awarding an award.

4. A gaming apparatus comprising a display and a user interface in communication with a game controller for providing a game in which a plurality of symbols are selected to form one or more outcomes and if a particular outcome results the gaming apparatus awards an award, the gaming apparatus operable to:
provide a first game event in which a first plurality of symbols are selected from a collection of symbols including one or more special symbols, to form one or more outcomes,
provide a second game event in which a second plurality of symbols are selected from a second collection of symbols to form one or more second outcomes, the second game event having at least one symbol with at least one variable characteristic that depends at least in part on the occurrence of the special symbols in the first game event; and
display on a display, or cause a display to display, representations of the first game event and the second game event.

5. The gaming apparatus of claim 4, wherein there are at least two different types of said special symbols, wherein the occurrence of a first type of special symbol results in variation of one or more characteristics of a first symbol in the second collection of symbols and the occurrence of a second type of special symbol results in variation of one or more characteristics of a second symbol in the second collection of symbols.

6. The gaming apparatus of claim 4, wherein the second collection of symbols comprises at least some of the same symbols from the first collection of symbols.

7. The gaming apparatus of claim 6, wherein the second collection of symbols comprise all or all but the special symbols from the first collection of symbols.

8. The gaming apparatus of claim 7, wherein the special symbols do not form part of the second collection of symbols.

9. The gaming apparatus of claim 4, wherein the second game event has enhanced play characteristics in comparison to the first game event, the enhanced play characteristics dependent at least in part on the occurrence of the special symbols in the first game event.

10. The gaming apparatus of claim 9, wherein the characteristic or characteristics that depend at least in part on the occurrence of the special symbols in the first game event are characteristics that result in the second game event having a higher return to player than the first game event.

11. The gaming apparatus of claim 4, wherein the second game event is a feature game that is provided on the occurrence of one or both of a particular said special symbol and a particular combination of said special symbols in the first game event.

12. The gaming apparatus of claim 4, wherein the first game event and second game event are defined by the spinning up of said symbols on a plurality of spinning reels.

13. The gaming apparatus of claim 4, wherein the special symbols each indicate to a player which symbol or symbols in the second collection of symbols are to have varied characteristics due to the occurrence of that special symbol.

14. The gaming apparatus of claim 4, wherein one part of each said special symbol indicates to a player that it is a special symbol and another part indicates to the player the symbols in the second collection of symbols are to have varied characteristics due to the occurrence of that special symbol.

15. The gaming apparatus of claim 4, wherein the variable characteristics of a symbol comprise at least one of:
a) the frequency of occurrence of the symbol;
b) whether the symbol substitutes for one or more other symbols to define a winning combination;
c) whether the symbol needs to be displayed in a particular symbol position to form part of a winning combination; and
d) whether the symbol has a multiplier associated with it that multiplies the award payable on the occurrence of a winning combination.

16. The gaming apparatus of claim 4, wherein the first game event comprises two stages, one stage comprising selecting what special symbols, if any, are selected and another stage selecting what other symbols in the collection of symbols are selected.

17. The gaming apparatus of claim 16, wherein the special symbols are associated with at least one of said other symbols, and said other symbols are present in the second game event and have at least one characteristic varied because of the association.

18. The gaming apparatus of claim 17, wherein the association is visually communicated to a player by locating the special symbol at the same symbol position as the symbol or symbols with which it is associated.

19. A method of providing a game, the method comprising in a computational gaming apparatus defining a collection of symbols and using the collection of symbols to form one or more outcomes, evaluating the outcomes for the occurrence of one or more winning outcomes and dependent on the evaluation award an award, the step of forming one or more outcomes comprising:
a) randomly selecting a plurality of symbols from the collection of symbols, the selected symbols defining a first set of symbols; and
b) randomly selecting a second set of symbols from the collection of symbols and associating each said further symbol with one or more of the first set of symbols, thereby defining one or more associated symbols in the first set of symbols; the method further comprising:
c) providing a feature game having enhanced play relative to said game and that uses at least part of the collection of symbols, wherein the enhanced play results from modification of at least one characteristic of at least one of the associated symbols; and
d) displaying on a display, or causing a display to display, representations of play of the game and the feature game.

20. A gaming apparatus comprising a display and a user interface in communication with a game controller for providing a game in which a plurality of symbols are selected from a collection of symbols to form one or more outcomes and if a particular outcome results the gaming apparatus awards an award, wherein the gaming apparatus operates to:
a) randomly select a plurality of symbols from the collection of symbols, the selected symbols defining a first set of symbols;
b) randomly select a second set of symbols from the collection of symbols and associating each said further symbol with one or more of the symbols from the first set of symbols, thereby defining one or more associated symbols in the first set of symbols;
c) provide a feature game having enhanced play relative to said game and that uses at least part of the collection of symbols, wherein the enhanced play results from modification of at least one characteristic of at least one of the associated symbols; and
d) display on the display representations of play of the game and the feature game.

21. The gaming apparatus of claim 20, which furither operates to use the first set of symbols and the second set of symbols to define the one or more outcomes;

22. The gaming apparatus of claim 20, wherein the feature game is provided on the occurrence of one or both of a particular symbol in the second set of symbols or a particular combination of symbols in the second set of symbols.

23. The gaming apparatus of claim 20, wherein the collection of symbols comprises a first collection and a second collection of symbols, wherein the first set of symbols are formed by selecting from the first collection and the second set of symbols are formed by selecting from the second collection. T

24. The gaming apparatus of claim 23, wherein the symbols in the first collection and the second collection are mutually exclusive.

25. The gaming apparatus of claim 24, wherein the symbols from the second collection are not used in the feature game.

26. The gaming apparatus of claim 23, wherein the game and the feature game are both spinning reel games that use the first collection of symbols on the spinning reels.

27. The gaming apparatus of claim 20, wherein the collection of symbols is defined by symbols on a plurality of reel strips each forming part of a spinning reel, and the step of forming one or more outcomes comprising spinning up the first set of symbols and the second set of symbols on the spinning reels.

28. The gaming apparatus of claim 27, wherein the one or more winning outcomes may include the spinning up of a predetermined combination of symbols on the spinning reels.

29. The gaming apparatus of claim 20, wherein the representations of play of the game comprise a representation of each symbol in the first set of symbols in a symbol position and a representation of the associated symbols in the same symbol position as the symbol in the first set of symbols with which they are associated.

30. The gaming apparatus of claim 29, wherein the size of the symbols in the first set of symbols is reduced so that both the symbol from the first set of symbols and its associated symbol may be displayed in the same symbol position.

31. The gaming apparatus of claim 29, wherein the second set of symbols includes a plurality of types of symbols, each type having multiple occurrences and enhanced play results from modification of at least one characteristic of every one of the multiple occurrences of a type of symbol.

32. The gaming apparatus of claim 20, wherein the at least one characteristic comprises at least one of:
a) the frequency of occurrence of the symbol;
b) whether the symbol substitutes for one or more other symbols to define a winning combination;
c) whether the symbol needs to be displayed in a particular symbol position to form part of a winning combination; and
d) whether the symbol has a multiplier associated with it that multiplies the award payable on the occurrence of a winning combination.

33. A method of determining an outcome of a game played on a computational gaming apparatus, the method comprising:
providing a first game event in which one or more first outcomes are formed by selecting a first plurality of symbols from a collection of symbols that includes a plurality of groups of related symbols, wherein for at least one of the groups of like symbols at least one, but less than all of the symbols in the group is designated a special symbol;
determining whether a trigger event has occurred during play of the first game event;
if the trigger event occurred during play of the first game event, determining whether a said special symbol has occurred in the first game event and if so, modifying the collection of symbols by changing at least one characteristic of all symbols in the same group as the special symbol and then providing a second game event in which one or more second outcomes are formed by selecting a second plurality of symbols from the modified collection of symbols;
evaluating whether a winning combination has occurred as a result of the first game event or the second game event and awarding an award if it is determined that a winning combination has occurred, wherein the modification to the collection of symbols results in at least one of an increased probability that a winning combination will occur in the second game event and the award of a larger award if a winning combination does occur in the second game event; and
displaying on a display, or causing a display to display representations of the first game event and the second game event.

34. The method of claim 33, wherein a symbol is designated as a said special symbol by having a background symbol associated with it, wherein the process of displaying or causing a display to display representations of the first game event include displaying in a same symbol display position any occurring special symbol and its associated background symbol.

35. The method of claim 33, wherein the relation between symbols in a group is identity.

36. A gaming apparatus comprising a display and a user interface in communication with a game controller for providing a game in which a plurality of symbols are selected from a collection of symbols to form one or more outcomes and if a particular outcome results the gaming apparatus awards an award, wherein the gaming apparatus operates to:
provide a first game event in which one or more first outcomes are formed by selecting a first plurality of symbols from a collection of symbols that includes a plurality of groups of related symbols, wherein for at least one of the groups of like symbols at least one, but less than all of the symbols in the group is designated a special symbol;
determine whether a trigger event has occurred during play of the first game event;
if the trigger event occurred during play of the first game event, determining whether a said special symbol has occurred in the first game event and if so, modifying the collection of symbols by changing at least one characteristic of all symbols in the same group as the special symbol and then providing a second game event in which one or more second outcomes are formed by selecting a second plurality of symbols from the modified collection of symbols;
evaluate whether a winning combination has occurred as a result of the first game event or the second game event and awarding an award if it is determined that a winning combination has occurred, wherein the modification to the collection of symbols results in at least one of an increased probability that a winning combination will occur in the second game event and the award of a larger award if a winning combination does occur in the second game event; and
display on a display, or causing a display to display representations of the first game event and the second game event.
